(19) United States
(12) Patent Application Publication
(10) Pub. No.: US 2020/0406517 A1
(43) Pub. Date: Dec. 31, 2020

(54) TRANSFER SHEET AND MOLDING METHOD USING SAME

(71) Applicant: NISSHA CO., LTD., Kyoto-shi, Kyoto (JP)

(72) Inventor: Shiro OKUNO, Kyoto (JP)

(73) Assignee: Nissha Co,. Ltd., Kyoto-shi, Kyoto (JP)

(21) Appl. No.: 16/646,668

(22) PCT Filed: Jul. 26, 2018
(86) PCT No.: PCT/JP2018/028061

§ 371 Date: Mar. 12, 2020

(30) Foreign Application Priority Data
Sep. 15, 2017 (JP) 2017-177908

(51) Int. Cl. B29C 45/14

(52) U.S. Cl. CPC B29C 45/14827; B29C 45/14008

(57) ABSTRACT

Provided are a transfer sheet and a molding method using the same, which enable easy cleaning and continuous use of a mold even if foreign matter is present on a cavity surface of the mold. The transfer sheet is configured such that a transfer layer is formed on one surface of a base sheet, and a foreign matter trapping layer is formed on the other surface of the base sheet. The molding method includes: a placement step of placing a transfer sheet so that the foreign matter trapping layer faces one cavity surface of a pair of molds; a molding step of clamping the pair of molds, injecting a molten resin into a molding space formed by clamping, pressing the foreign matter trapping layer against the cavity surface, and molding a molded article integrated with the transfer sheet; a mold-opening step of opening the pair of molds; a peeling step of peeling off the transfer sheet from the molded article; and a removal step of removing the molded article.

### TECHNICAL FIELD

The present invention relates to a transfer sheet and a molding method using the same.

### BACKGROUND ART

Conventionally, in a molding method for performing injection molding using the transfer sheet, a so-called dent has been a problem. When the transfer sheet is placed in a state where foreign matter such as dust or foil burr is left on a cavity surface of a mold and the injection molding is performed, since a shape of the foreign matter is transferred to a surface of a molded article, a recess is formed. The recess is called the dent. In the molding method using the transfer sheet, there has been a big problem that the dent is continuously generated in the molded article because the foreign matter stays on the cavity surface of the mold, or the foreign matter floating in the air newly adheres to the cavity surface of the mold.

As the transfer sheet for preventing the dent, for example, in a transfer sheet 11 disclosed in PATENT LITERATURE 1, a tacky layer 10 is formed on a surface of a base sheet 12 opposite to a surface on which a transfer layer 13 is formed (see FIG. 4A). The transfer sheet 11 is placed so that the tacky layer 10 faces one cavity surface b of molds 17, 17, and the injection molding is performed, so that the foreign matter remaining on the cavity surface is removed by the tacky layer, thereby preventing the dent.

### CITATION LIST

### Patent Literature

PATENT LITERATURE 1: JP-A-2004-358867

### SUMMARY OF THE INVENTION

### Problems to be Solved by the Invention

However, in the transfer sheet as disclosed in PATENT LITERATURE 1, the base sheet peeled after the injection molding adheres to the cavity surface of the mold by the tacky layer. Therefore, there has been a problem that it takes a lot of trouble to peel off the base sheet from the cavity surface. Further, when the base sheet is peeled off from the cavity surface, since a part of the tacky layer remains on a molding surface, there has been a problem that the mold is even more contaminated, and the molding must be stopped to remove it.

The present invention has been made to solve the above problems. An object of the present invention is to provide a transfer sheet and a molding method using the same, which enable easy cleaning and continuous use of the mold even if the foreign matter is present on the cavity surface of the mold.

### Solution to the Problems

Hereinafter, a plurality of aspects will be described as means for solving the problems. The aspects can be arbitrarily combined as needed.

A transfer sheet of the present invention is a sheet in which a transfer layer is formed on one surface of a base sheet, and a foreign matter trapping layer is formed on the other surface of the base sheet.

The transfer sheet may be a layer that at least a pattern layer and an adhesive layer are laminated in order from a side close to the base sheet in the transfer layer.

A molding method according to the present invention includes: a placement step of placing a transfer sheet in which a transfer layer is formed on one surface of a base sheet and a foreign matter trapping layer is formed on the other surface of the base sheet so that the foreign matter trapping layer faces one cavity surface of a pair of molds; a molding step of clamping the pair of molds, injecting a molten resin into a molding space formed by clamping, pressing the foreign matter trapping layer against the cavity surface, and molding a molded article integrated with the transfer sheet; a mold-opening step of opening the pair of molds; a peeling step of peeling off the transfer sheet from the molded article; and a removal step of removing the molded article.

### Effects of the Invention

The transfer sheet of the present invention is configured such that the transfer layer is formed on the one surface of the base sheet, and the foreign matter trapping layer is formed on the other surface of the base sheet. Therefore, the transfer sheet of the present invention enables easy cleaning and continuous use of the mold even if the foreign matter is present on the molding surface of the mold.

The molding method according to the present invention is configured to include: a placement step of placing a transfer sheet in which a transfer layer is formed on one surface of a base sheet and a foreign matter trapping layer is formed on the other surface of the base sheet so that the foreign matter trapping layer faces one cavity surface of a pair of molds; a molding step of clamping the pair of molds, injecting a molten resin into a molding space formed by clamping, pressing the foreign matter trapping layer against the cavity surface, and molding a molded article integrated with the transfer sheet; a mold-opening step of opening the pair of molds; a peeling step of peeling off the transfer sheet from the molded article; and a removal step of removing the molded article. Therefore, the molding method of the present invention enables easy cleaning and continuous use of the mold even if the foreign matter is present on the cavity surface of the mold.

### BRIEF DESCRIPTION OF THE DRAWINGS

FIG. 1 is a cross-sectional view showing an example of an embodiment of a transfer sheet.

FIG. 2 is a cross-sectional view showing an example of the embodiment of the transfer sheet.

FIGS. 3A to 3F are cross-sectional views showing an example of an embodiment of a molding method.

FIGS. 4A and 4B are cross-sectional views showing an example of a conventional transfer sheet and molding method.

### DESCRIPTION OF THE EMBODIMENTS

Hereinafter, an example of an embodiment of a transfer sheet and a molding method using the same of the present invention will be described with reference to the drawings.

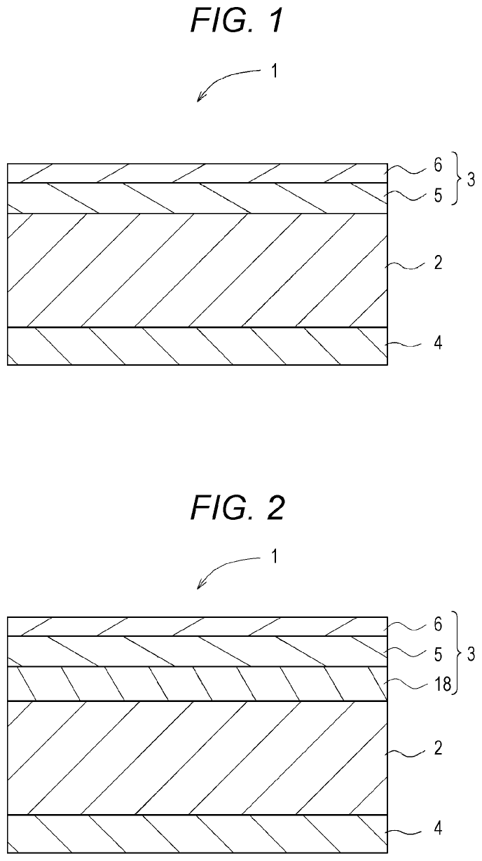

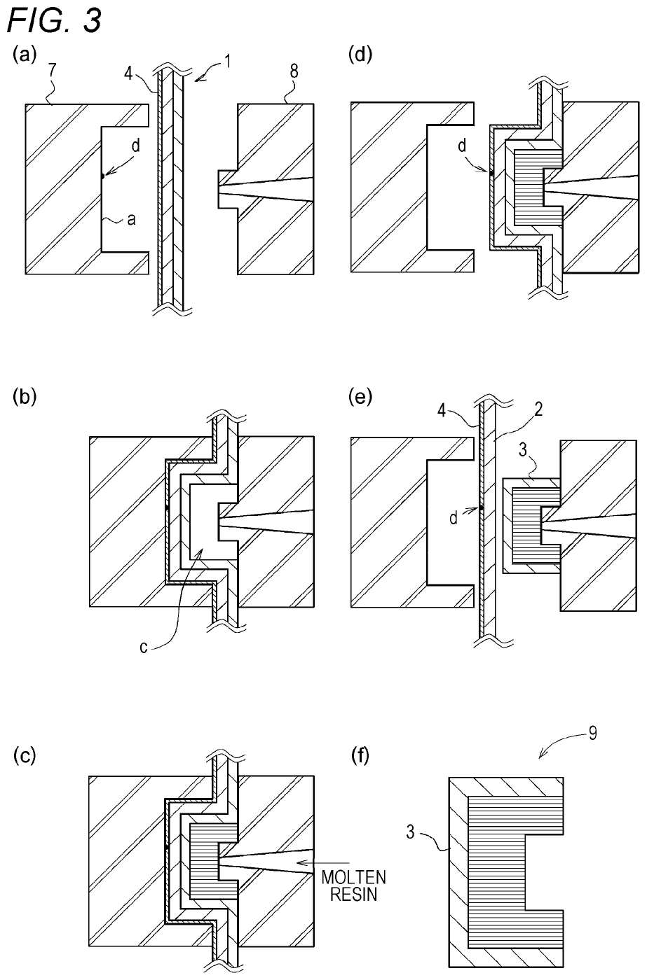

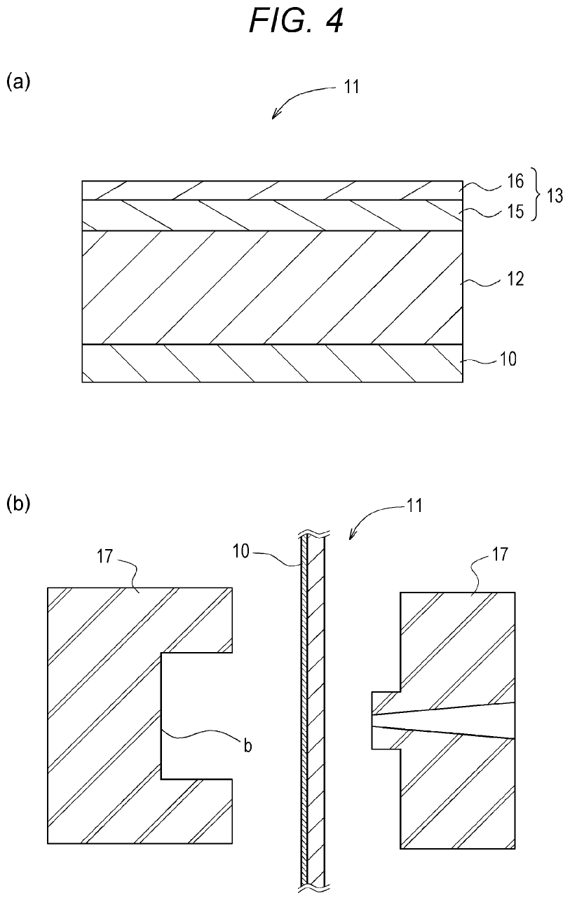

The molding method of the present embodiment includes: a placement step of placing a transfer sheet 1 in which a transfer layer 3 is formed on one surface of a base sheet 2 and a foreign matter trapping layer 4 is formed on the other surface of the base sheet so that the foreign matter trapping layer 4 faces one cavity surface a of a pair of molds 7 and 8; a molding step of clamping the pair of molds 7 and 8, injecting a molten resin into a molding space c formed by clamping, pressing the foreign matter trapping layer 4 against the cavity surface a, and molding a molded article 9 integrated with the transfer sheet 1; a mold-opening step of opening the pair of molds 7 and 8; a peeling step of peeling off the transfer sheet 1 from the molded article 9; and a removal step of removing the molded article 9 (see FIGS. 1 and 3).

### (Placement Step)

The placement step is the step of placing the transfer sheet 1 in which the transfer layer 3 is formed on the one surface of the base sheet 2 and the foreign matter trapping layer 4 is formed on the other surface of the base sheet so that the foreign matter trapping layer 4 faces the one cavity surface a of the pair of molds 7 and 8 (see FIG. 3A).

The transfer sheet 1 is the sheet in which the transfer layer 3 is formed on the one surface of the base sheet 2 and the foreign matter trapping layer 4 is formed on the other surface of the base sheet 2 (see FIG. 1).

### (Base Sheet)

The base sheet 2 is a sheet that is peeled off from the molded article after injection molding using the transfer sheet 1. Examples of materials of the base sheet 2 include thermoplastic resins such as a polypropylene-based resin, a polyethylene-based resin, a polyamide-based resin, an acrylic-based resin, an olefin-based resin, a polyester-based resin, a PVC-based resin, a polycarbonate-based resin, and an ABS-based resin, and a laminate thereof. Note that a release layer (not shown) may be laminated on the base sheet 2 in order to further improve release properties of the base sheet 2. The release layer is released together with the base sheet 2 when the base sheet 2 is released.

### (Transfer Layer)

The transfer layer 3 is a layer formed on the base sheet 2. Examples of methods of forming the transfer layer 3 include normal printing methods such as a gravure printing method, a screen printing method and an offset printing method, and coating methods such as a gravure coating method, a roll coating method, and a die coating method. In the transfer layer 3, at least a pattern layer 5 and an adhesive layer 6 may be laminated in order from a side close to the base sheet 2 (see FIG. 1). The pattern layer 5 may be formed on an entire surface, or may be formed in an arbitrary pattern. Decorativeness of the molded article can be improved by the pattern layer 5. Examples of materials of the pattern layer 5 include resins such as an acrylic-based resin, a vinyl chloride-vinyl acetate copolymer resin, a thermoplastic urethane-based resin, and a polyester-based resin, and a pigment or a dye added to the resins. The pattern layer 5 may be, for example, a metal thin film layer formed by vapor depositing a metal using a vacuum evaporation method or a sputtering method, or may be formed by applying an etching method to the metal thin film layer. The pattern layer 5 may be given a metallic design using, for example, an aluminum paste or a pearl pigment. The pattern layer 5 can be formed to have a thickness of, for example, several hundred nm to several tens μm. Note that the pattern layer 5 may be a layer that gives the molded article a matte texture after the base sheet is peeled off. As a material of the adhesive layer 6, a heat-sensitive or pressure-sensitive resin can be appropriately selected and used. Examples of the resin include an acrylic-based resin, a polystyrene-based resin, a polyamide-based resin, a chlorinated polyolefin resin, a chlorinated ethylene-vinyl acetate copolymer resin, a cyclized rubber, and a coumarone indene resin. The resins are appropriately selected depending on the material of the molded article. A thickness of the adhesive layer can be 0.1 μm to 50 μm.

Further, the transfer layer 3 may include a protective layer 18 (see FIG. 2). The protective layer 18 is a layer that is an outermost surface of the molded article after the base sheet 2 is peeled off. Examples of materials of the protective layer include thermoplastic resins such as an acrylic-based resin, a polystyrene-based resin, a polyamide-based resin, a chlorinated polyolefin resin, a chlorinated ethylene-vinyl acetate copolymer resin, a cyclized rubber, and a coumarone indene resin. By forming the protective layer with such a thermoplastic resin, the molded article can be imparted with chemical resistance and the like. Further, the protective layer can be formed to include any of a photocurable resin such as an ultraviolet curable resin, a radiation curable resin such as an electron beam curable resin, and a thermosetting resin as other materials. Examples of such resins include a urethane acrylate-based resin, a cyanoacrylate-based resin, an epoxy acrylate-based resin, a polyester acrylate-based resin, and a resin obtained by adding additives such as isocyanate to these resins. By forming the protective layer with the above curable resin, the molded article can be imparted with physical properties such as durability and abrasion resistance. A thickness of the protective layer 18 can be 0.5 μm to 10 μm.

### (Foreign Matter Trapping Layer)

Materials of the foreign matter trapping layer 4 is not particularly limited as long as a foreign matter d attached to the cavity surface a of the mold can be removed. However, the foreign matter trapping layer 4 is formed of a material that is softer than the base sheet 2 and has a property of low resilience. Such materials include polyester resins such as a linear saturated polyester, vinyl chloride resins such as polyvinyl chloride, a vinyl acetate resin, and a vinyl chloride-vinyl acetate copolymer resin, vinyl-based resins such as polystyrene, polydivinylbenzene, polyvinylbenzene, a styrene-butadiene copolymer resin, and styrene and alkyl methacrylate (where the alkyl group has 1 to 6 carbon atoms), acrylic resins such as polyacrylic acid, poly(2-methoxyethylacrylate), polymethyl acrylate, poly(2-naphthyl acrylate), poly(isobornyl acrylate), polymethacrylomethyl, polyacrylonitrile, polymethylchloroacrylate, polymethyl methacrylate, polyethyl methacrylate, poly(tert-butyl methacrylate), poly(isobutyl methacrylate), polyphenyl methacrylate, and a copolymer resin of methyl methacrylate and alkyl methacrylate (where the alkyl group has 2 to 6 carbon atoms), synthetic resins such as chlorinated rubber, and cyclized rubber, natural resins such as rosin and a rosin ester resin, a polyethylene resin, a polypropylene resin, a nylon resin, a polyurethane resin, an epoxy resin, a fluororesin, a silicon resin, an alkyd resin, an amino resin, a polyvinyl alcohol resin, a polyimide resin, a polyamide resin, and butyral resin.

Examples of methods for forming the foreign matter trapping layer 4 include normal printing methods such as a gravure printing method, a screen printing method, and an offset printing method, and coating methods such as a gravure coating method, a roll coating method, and a die coating method. With the methods, the foreign matter trapping layer 4 can be formed directly on the base sheet 2. Further, the sheet-like foreign matter trapping layer 4 can be bonded to the base sheet 2. Further, the foreign matter trapping layer 4 can be formed on the base sheet 2 by direct melting and extrusion. Furthermore, the foreign matter trapping layer 4 can be formed on the base sheet 2 simultaneously with forming the base sheet 2, and further by stretching it. A thickness of the foreign matter trapping layer can be 0.1 μm to 1 μm, and may be further increased as long as surface properties of the molded article are not affected.

The transfer sheet 1 is placed so that the foreign matter trapping layer 4 faces the one cavity surface a of the pair of molds 7 and 8 (see FIG. 3A). The mold 7 is a movable mold, and the mold 8 is a fixed mold. The transfer sheet 1 is unwound from an unwinding portion of a feeding device (not shown) at the upper side of the drawing, is supplied between the molds 7 and 8, and is placed so that the cavity surface a of the movable mold 7 and the pattern layer 5 are aligned. After molding, the transfer sheet 1 is wound by a winding portion of the feeding device. After the transfer sheet 1 is placed, the transfer sheet 1 may be fixed to the movable mold 7 by a clamp mechanism (not shown).

### (Molding Step)

The molding step is a step of clamping the pair of molds 7 and 8, injecting the molten resin into the molding space c formed by the clamping, pressing the foreign matter trapping layer 4 against the cavity surface a, and molding the molded article 9 integrated with the transfer sheet 1 (see FIGS. 3B and 3C).

As the molten resin, general-purpose resins such as a polystyrene-based resin, a polyolefin-based resin, an ABS resin, an AS resin, and an AN resin can be used. In addition, general-purpose engineering resins such as a polyphenylene oxide/polystyrene-based resin, a polycarbonate-based resin, a polyacetal-based resin, an acrylic-based resin, a polycarbonate-modified polyphenylene ether resin, a polybutylene terephthalate resin, and an ultrahigh molecular weight polyethylene resin, and super engineering resins such as a polysulfone resin, a polyphenylene sulfide-based resin, a polyphenylene oxide-based resin, a polyarylate resin, a polyetherimide resin, a polyimide resin, a liquid crystal polyester resin, and a polyallyl-based heat resistant resin can also be used. Further, a composite resin added with reinforcing materials such as glass fiber and an inorganic filler can also be used.

The foreign matter trapping layer 4 is pressed against the cavity surface a of the movable mold 7 by an injection pressure of the molten resin. Thus, the foreign matter d such as dust present on the cavity surface a can be taken into the foreign matter trapping layer 4. More specifically, the foreign matter trapping layer 4 is pressed against the cavity surface a by the injection pressure, so that the foreign matter d deeply penetrates into the foreign matter trapping layer or pierces into the foreign matter trapping layer. Thus, the foreign matter d can be taken into the foreign matter trapping layer.

Further, the foreign matter trapping layer 4 is further softened by heat of the molten resin and the mold 7. Therefore, since the softened foreign matter trapping layer 4 is pressed against the cavity surface a by the injection pressure, the foreign matter d can be more easily taken into the foreign matter trapping layer 4. After the injection molding, the molded article is cooled, and the foreign matter trapping layer 4 is also cooled and returns to an original softness. Therefore, the trapped foreign matter can be reliably held in the foreign matter trapping layer 4.

Note that a suction hole (not shown) may be provided in the cavity surface a. The suction hole is connected to a vacuum pump (not shown). After or simultaneously with the clamping, the transfer sheet 1 can be sucked and made to follow the cavity surface a.

### (Mold-Opening Step)

The mold-opening step is a step of opening the pair of molds 7 and 8 (see FIG. 3D). After the molding step, the movable mold 7 is moved to open the mold. When the transfer sheet 1 is sucked through the suction hole, suction is interrupted before or simultaneously with the mold-opening. In the molding step, the foreign matter d on the cavity surface a is taken into the foreign matter trapping layer 4. By opening the mold, the foreign matter d moves from the cavity surface a to the foreign matter trapping layer 4 of the transfer sheet 1. That is, the foreign matter d can be removed from the cavity surface a by the molding step and the mold-opening step. Further, since the foreign matter trapping layer 4 has no tackiness or adhesiveness, it easily separates from the cavity surface a and does not contaminate the cavity surface a when the mold is opened.

The molded article may be ejected toward the movable mold 7 by an ejector pin (not shown) simultaneously with or after the mold-opening.

### (Peeling Step)

The peeling step is a step of peeling the transfer sheet 1 from the molded article (see FIG. 3E). By the peeling step, the base sheet 2 and the transfer layer 3 of the transfer sheet 1 can be separated from each other. The foreign matter d present on the cavity surface a is taken into the foreign matter trapping layer 4. After the peeling step, the winding portion and the unwinding portion of the feeding device are operated to feed the transfer sheet 1 downward in the drawing, and the transfer layer used in the next molding is placed on the cavity surface a. As described above, the foreign matter d is taken into the foreign matter trapping layer 4 of the transfer sheet 1, and in the next placement step, a new foreign matter trapping layer 4 free of the foreign matter always faces the cavity surface a. Therefore, the foreign matter d can be reliably removed. That is, even if the foreign matter d is present on the cavity surface a, it can be easily cleaned and the mold can be used continuously.

### (Removal Step)

The removal step is a step of removing the molded article 9 (see FIG. 3F). When removing the molded article 9, for example, a robot arm can be used. It is preferred that a suction cup connected to the vacuum pump is disposed at a molded article holding portion of the arm, so that the molded article 9 is sucked and removed by a negative pressure.

### MODIFICATION

In the above embodiment, the mold-opening step and the peeling step are performed separately, however, they may be performed simultaneously. This can be achieved by continuing the suction of the transfer sheet 1 of the movable mold 7 when the mold is opened. That is, the base sheet 2 and the transfer layer 3 can be separated by a suction force, and the peeling step can be performed. Further, since the base sheet 2 is sucked to the cavity surface a, it is possible to prevent the cavity surface a from being damaged and to prevent the foreign matter such as the dust floating in the air from adhering to the cavity surface a when the molded article is removed. After the peeling step, by interrupting the suction to separate the base sheet 2 from the cavity surface a, the foreign matter d can be removed from the cavity surface a.

### LIST OF REFERENCE NUMERALS

1, 11: transfer sheet, 2, 12: base sheet, 3, 13: transfer layer, 4: foreign matter trapping layer, 5, 15: pattern layer, 6, 16: adhesive layer, 7, 8, 17: mold, 9: molded article, 10: tacky layer, 18: protective layer, a, b: cavity surface, c: molding space, d: foreign matter.

1. A transfer sheet in which a transfer layer is formed on one surface of a base sheet, and a non-adhesive foreign matter trapping layer is formed on the other surface of the base sheet, wherein
the non-adhesive foreign matter trapping layer is formed of at least one material selected from the group consisting of polyester resin, vinyl chloride resin, vinyl acetate resin, vinyl chloride-vinyl acetate copolymer resin, polystyrene resin, polydivinylbenzene resin, polyvinylbenzene resin, styrene-butadiene copolymer resin, polyacrylic acid resin, poly(2-methoxyethylacrylate) resin, poly(methylacrylate) resin, poly(2-naphthyl acrylate) resin, poly(isobornyl crylate) resin, polymethacrylomethyl resin, polyacrylonitrile resin, poly(methyl chloroacrylate) resin, poly(methyl methacrylate) resin, poly(ethyl methacrylate) resin, poly(tert-butyl methacrylate) resin, poly(isobutyl methacrylate) resin, poly(phenyl methacrylate) resin, copolymer resin of methyl methacrylate and alkyl methacrylate (where the alkyl group has 2 to 6 carbon atoms), chlorinated rubber, cyclized rubber, rosin ester resin, polyethylene resin, polypropylene resin, nylon resin, polyurethane resin, epoxy resin, fluororesin, silicone resin, alkyd resin, an amino resin, polyvinyl alcohol resin, polyimide resin, polyamide resin, and butyral resin.

2. The transfer sheet according to claim 1, wherein at least a pattern layer and an adhesive layer are laminated in order from a side close to the base sheet in the transfer layer.

3. A molding method comprising:
a placement step of placing a transfer sheet in which a transfer layer is formed on one surface of a base sheet and a non-adhesive foreign matter trapping layer is formed on the other surface of the base sheet so that the non-adhesive foreign matter trapping layer faces one cavity surface of a pair of molds;
a molding step of clamping the pair of molds, injecting a molten resin into a molding space formed by clamping, pressing the non-adhesive foreign matter trapping layer against the cavity surface, and molding a molded article integrated with the transfer sheet;
a mold-opening step of opening the pair of molds and of removing the molded article integrated with the transfer sheet from the mold with the one cavity surface;
a peeling step of peeling off the transfer sheet from the molded article; and
a removal step of removing the molded article.

4. The transfer sheet according to claim 1, wherein
the base sheet is formed of at least one material selected from the group consisting of polypropylene resin, polyethylene resin, polyamide resin, acrylic-based resin, polyolefin resin, polyester resin, PVC resin, polycarbonate resin, and ABS resin.

5. The transfer sheet according to claim 4, wherein the non-adhesive foreign matter trapping layer has a low resilience to be softer than the base layer.

6. The transfer sheet according to claim 4, wherein the non-adhesive foreign matter trapping layer has a thickness of 0.1 μm to 1.0 μm.

7. The transfer sheet according to claim 5, wherein the non-adhesive foreign matter trapping layer has a thickness of 0.1 μm to 1.0 μm.
